(19) United States
(12) Patent Application Publication
(10) Pub. No.: US 2005/0139652 A1
(43) Pub. Date: Jun. 30, 2005

(54) Information reading device and information reading system

(75) Inventor: Takahiro Iwamura, Kawanishi-shi (JP)

Correspondence Address: RATNERPRESTIA, P O BOX 980, VALLEY FORGE, PA, 19482-0980, US

(73) Assignee: Matsushita Electric Industrial Co., Ltd.

(21) Appl. No.: 11/018,066

(22) Filed: Dec. 21, 2004

(30) Foreign Application Priority Data
Dec. 25, 2003 (JP) 2003-429456

(51) Int. Cl. G06K 5/00; G06K 7/08

(52) U.S. Cl. 235/380; 235/449

(57) ABSTRACT

In a card reader of a card reading system corresponding to an infrastructure for a magnetic card to be made applicable commonly for an IC card, a decoding circuit converts an analog signal of magnetic card data to a digital signal in waveform and a transmission and reception circuit receives IC card data. A microprocessor enciphers the IC card data received through the transmission and reception circuit and produces the waveforms of the enciphered data having the same specification as that of the magnetic card data outputted of the decoding circuit. In a terminal, when the input card data is identified as the magnetic card data based on a discrimination signal, the received card data is not processed, and when identified as the IC card data, the received card data is deciphered by a data processing portion.

### BACKGROUND OF THE INVENTION

1. Field of the Invention

The present invention relates to an information reading device and to an information reading system using a data carrier such as an IC card in common with a magnetic card adaptable to a magnetic card system corresponding to a magnetic card infrastructure.

2. Description of the Related Art

In recent years, although a magnetic card has been widely used as a debit card, a credit card and the like, damages and disadvantages by forgery or unauthorized use are increasing due to weakness in security. As a defense measure for preventing such forgery or unauthorized use, it is considered to change or modify a magnetic card system using a magnetic card to an IC card system using an integrated circuit card (referred to as “IC card”, hereinafter) and introduce an IC card system in various fields. This is because an IC card system has more excellent ability in security compared to a magnetic card system. However, immense investments are needed in order to change the infrastructures widely used for a magnetic card system such as various existing terminals and networks to those adapted for an IC card system. Therefore, the change to the IC card system has not been developed so much yet in the present condition.

While a key point of developing an IC card system is to make effective use of all-purpose flexibility and convenience thereof, it is also an important point to achieve a seamless change from the infrastructure for the existing magnetic card system to that for the IC card system. In addition, regarding a seamless transition of an infrastructure in a card system, there has been proposed a known conventional technique, for example, as disclosed in Patent Document 1: Japanese Patent Laid-open Publication No. H4-195380. In this document 1, an IC card reader/writer is provided with a communication data conversion interface in order to have the same communication specification as that of magnetic card data.

FIG. 9 shows a schematic block diagram of a conventional card system as disclosed in the Patent Document 1. As shown in FIG. 9, the card system includes a card-operated vending machine 101 which is connected to connector 107 via a control bus line 108. The connector 107 can be connected to both a magnetic card reader/writer 109 and an IC card reader/writer 111 in common.

In FIG. 9, the card-operated vending machine 101 includes a main control portion 102 serving as a master controller, a display control portion 103, an article carrier control portion 104, a coin counter control portion 105, and a key input control portion 106. The connector 107 is connected to the main control portion 102 through the control bus line 108. The magnetic card reader/writer 109 having a communication interface 110 is connected to the main control portion 102 for reading/writing process of a magnetic card. Thus, the main control portion 102 controls the whole parts of the vending machine, while sending and receiving data of the magnetic card and sending a command to the communication interface 110 via the connector 107 by polling.

For transmission of data of an IC card to the card-operated vending machine 101, the IC card reader/writer 111 includes a communication interface 112 and a communication data conversion interface 113 connected with each other. Data of an IC card is read by the IC card reader/writer 111, and the data read by the IC card reader/writer 111 is sent to the communication data conversion interface 113 through the communication interface 112. In the communication data conversion interface 113, the received data of the IC card is converted in specification to have the same communication specification as that of the magnetic card data read by the magnetic card reader/writer 109, and then the resultant converted data of the IC card is sent to the main control portion 102.

By this arrangement, the IC card reader/writer 111 can be connected to the connector 107 for connecting the existing magnetic card reader/writer 109 without any change in construction of the card-operated vending machine 101 having an interface adapted for the magnetic card reader/writer, so that an IC card can be commonly used in the magnetic card system.

However, in many of magnetic card readers connected to a conventional magnetic card system, card data reproduced through a magnetic head is separated into a clock signal serving as a data distinction timing signal and a data signal to be outputted by a decode circuit. These separated output signals are transmitted to a major or host device as they are, without being subject to an electric interface of a physical medium and frame-formula conversion, encryption and the like processing for the data transmission. Therefore, in this conventional card system, since the information stored in an IC card will only be read in a data format same as the recording format of the magnetic card data and outputted to the external of the card reader/writer without being subject to encryption and the like processing.

As a result, there arises a problem that the IC card data becomes guardless to a theft or tapping in this conventional system. Therefore, the information in the IC card may be stolen by scheming, or forgery of an IC card by copying the IC card data onto a magnetic card may be performed easily. Thus, there is a problem that, the change from a magnetic card system to an IC card system becomes meaningless in achieving an original object. That is, although the original object of using the IC card system is to make it more difficult to illegally read information, preventing forgery of information to secure higher safety compared to a magnetic card system, this object can not be achieved in the conventional card system.

### SUMMARY OF THE INVENTION

The present invention has been made to solve the problem mentioned above and has an object to provide an information reading device and an information reading system using a data carrier such as an IC card in common with a magnetic card adaptable to a magnetic card system, attaining a remarkable security function, with large reduction in investment cost for dedicating to an IC card infrastructure in common to a magnetic card infrastructure.

In order to achieve the object mentioned above, an information reading device according to a first aspect of the present invention includes: a first receiving portion receiving information from a data carrier; a microprocessor having an enciphering function of enciphering the information received by the first receiving portion; and a communicating portion adapted to transmit the enciphered information to a host device to thereby communicate with the host device. In this construction, the information enciphered by the microprocessor is transmitted as a clock signal and a data signal to the host device through the communicating portion.

Moreover, in an information reading system which is a combination of the information reading device and the host device receiving information from the information reading device, the host device includes: a second receiving portion receiving the information transmitted from the information reading device; and a deciphering portion adapted to decipher the enciphered information transmitted from the information reading device.

By this arrangement, in the established information reading system adapted to read a magnetic card, it becomes possible to apply a magnetic card reading device to an IC card reading device commonly using a data carrier with only a minimal change in software without any change in a circuit arrangement of the host device. Moreover, since the information transmitted on the connection interface between the information reading device and the host device is enciphered, forgery of the card information can be made difficult.

An information reading device according to a second aspect of the present invention includes: a magnetic information reading portion reading information from a magnetic recording medium; a first receiving portion receiving information from a data carrier; a microprocessor having an enciphering function of enciphering the information received by the information receiving portion; and a communicating portion adapted to selectively receive one of the information read by the magnetic information reading portion and the enciphered information enciphered by the microprocessor and transmit the selectively received information to a host device to thereby communicate with the host device.

In this construction, the information selectively received by the communicating portion is transmitted as a clock signal and a data signal to the host device while discrimination information is transmitted from the information reading device to the host device in order for discriminating whether the transmitted information is the information read by the magnetic information reading portion or the information received by the information receiving portion.

Preferably, when the microprocessor enciphers the information received by the information receiving portion, the number of characters of the received information may be elongated to exceed the maximum limit number of characters recordable on a magnetic stripe region of a magnetic card according to the recording specification defined in the International Standard of ID card.

Preferably, in this construction, the discrimination information having a specific pattern indicating the transmission data being the information received from the data carrier may be superposed on the clock signal and/or the data signal to be transmitted from the communicating portion to the host device.

Moreover, in an information reading system which is a combination of the information reading device and the host device receiving information from the information reading device, the host device includes: a second receiving portion receiving the information and the discrimination information transmitted from the information reading device; and a deciphering portion adapted to decipher the enciphered information transmitted from the information reading device in the case where the discrimination information indicates that the transmitted information is the information received by the first receiving portion.

By this arrangement, the information reading system established for reading a magnetic card can be easily upgraded to a combined card system to which a magnetic card and a data carrier can be commonly adapted with only a minimal change in software without changing a circuit arrangement of the host device. Moreover, the information received from the data carrier is enciphered and the number of the characters thereof is elongated. Therefore, even if information of a data carrier is copied to a usual magnetic card, the entire elongated characters data can not be stored in the magnetic stripe of the magnetic card, thus preventing forge of an IC card.

### BRIEF DESCRIPTION OF THE DRAWINGS

These and other objects and features of the present invention will be readily understood from the following detailed description taken in conjunction with preferred embodiments thereof with reference to the accompanying drawings in which:

FIG. 1 is a block diagram showing a construction of a card system according to a first embodiment of the present invention;

FIG. 2A is a schematic diagram showing an example of a terminal provided in the card system according to the first embodiment of the present invention;

FIG. 2B is a side view of the terminal shown in FIG. 2A;

FIG. 3A shows a magnetic stripe of a magnetic card, FIG. 3B shows a magnetic reading signal, FIG. 3C shows a clock signal and FIG. 3D shows a data signal;

FIG. 4A shows a magnetization pattern of the magnetic stripe, FIG. 4B shows a reproduction waveform reproduced by a magnetic head, FIG. 4C shows a clock waveform and FIG. 4D shows a data waveform;

FIG. 5A is a plan view showing a structure of a slot type card reader to which a magnetic card is inserted according to a first embodiment of the present invention;

FIG. 5B is a partial section view of the slot type card reader shown in FIG. 5A;

FIG. 6 is a block diagram showing a construction of a card system according to a second embodiment of the present invention;

FIG. 7A is an explanatory view showing an example of the card data when information of a magnetic card is read according to a second embodiment of the present invention;

FIG. 7B is an explanatory view showing another example of the card data when information of an IC card is read according to the second embodiment of the present invention;

FIG. 8 is an explanatory view showing an example of a clock and data signals when transmitting identification information as a part of the data according to the second embodiment of the present invention;

FIG. 9 is a block diagram showing a conventional construction of a card-operated vending machine to which a conventional card reader/writer is connected.

### DETAILED DESCRIPTION OF THE PREFERRED EMBODIMENTS

Before the description proceeds, it is to be noted that, since the basic structures of the preferred embodiments are in common, like parts are designated by the same reference numerals throughout the accompanying drawings.

### Embodiment 1

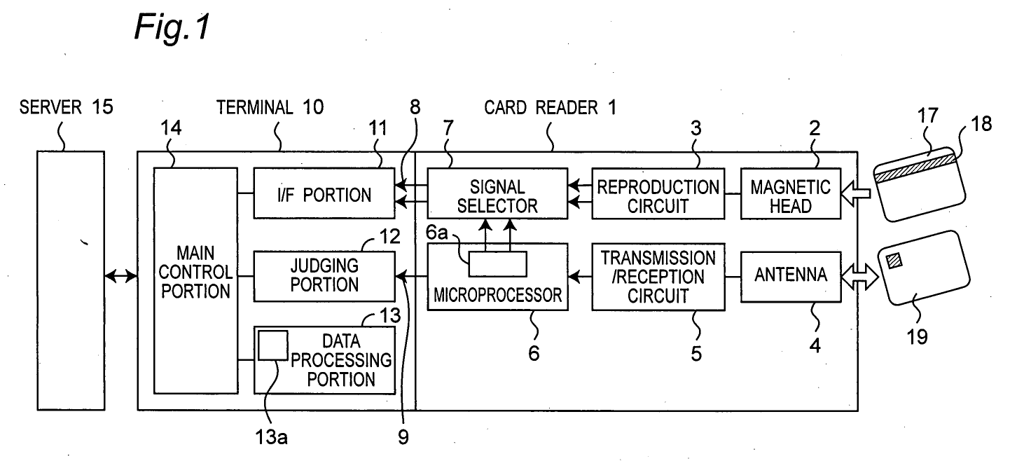

Hereafter, a first embodiment of the present invention is described with reference to FIGS. 1, 2A-2B, 3A-3D, 4A-4D and 5A-5B.

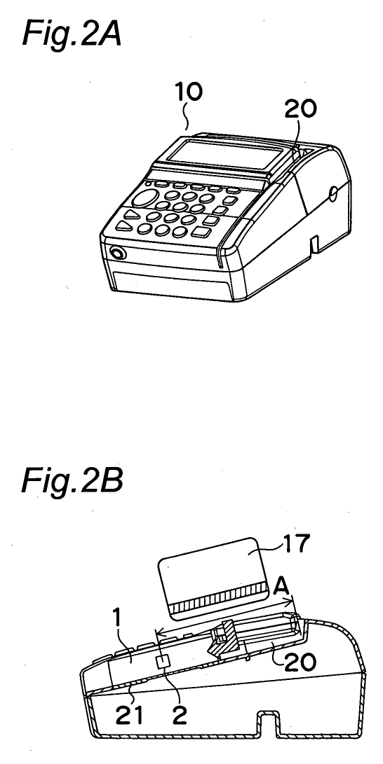

FIG. 1 shows a card system of the first embodiment comprised of a card reader 1 incorporated in a terminal 10 which is connected to a server 15 of a center station via a network. As an example of the terminal 10, there may be a settlement terminal device which performs a settlement of accounts, using a card. A settlement terminal device as an example of the terminal 10 is shown in FIGS. 2A and 2B, wherein FIG. 2A is a perspective view thereof and FIG. 2B is a partial section view showing an essential part thereof.

In FIG. 1, reference numeral 1 denotes a combined card reader which is allowed to process in common both a magnetic card 17 as an example of a magnetic recording medium and a contactless IC card 19 as an example of a data carrier. The card reader 1 includes a magnetic head 2 for reading information stored in a magnetic stripe 18 of the magnetic card 17, a reproduction circuit 3 which processes for decoding of the information read by the magnetic head 2 to be sent to the terminal 10. The card reader 1 further includes an antenna 4 for communicating with the contactless IC card 19, a transmission and reception circuit 5 for transmitting and receiving the card information, a microprocessor (CPU) 6 for controlling whole parts of the card reader, a signal selector 7 which selectively switches a communication line of the information to be sent to the terminal.

In the decoding circuit 3, an analog signal of the information read from the magnetic card 17 through the magnetic head is converted to a digital signal of the decode data. Moreover, in the decoding circuit 3, the reproduction data is separated into a clock signal and a data signal as the output waveforms and these clock and data signals are then inputted to the signal selector 7. Thus, the decoding circuit 3 includes a waveform generating means (not shown) for generating a clock signal waveform and a data signal waveform where the clock signal acts as a data distinction timing signal.

The microprocessor 6 controls the whole parts of the card reader 1, performing the control of such as transmission and reception of the information to and from the contactless IC card 19, encryption of the information received from the contactless IC card 19 and sending the information to the terminal 10, and performing a switching control of the signal selector 7. More specifically, the microprocessor 6 includes an enciphering function 6a for enciphering the information received from the contactless IC card 19 through the antenna 4 and the transmission and reception circuit 5.

A transmission command outputted by the microprocessor 6 is modulated by the transmission and reception circuit 5 and is then sent to the contactless IC card 19 through the antenna 4. Contrariwise, in response to the transmission command, a response generated from the contactless IC card 19 is received by the antenna 4 and is demodulated by the transmission and reception circuit 5 and is then transmitted to the microprocessor 6.

The signal selector 7 outputs card data 8 consisting of the clock signal and data signal, which are sent to the terminal 10. More specifically, the card data 8 is inputted to an interface (I/F) portion 11 of the terminal 10 which serves as a communication interface in connection with the card reader 1.

In this construction, the signal selector 7 selectively switches the information to be transmitted to the terminal 10 based on a switching control signal supplied from the microprocessor 6. More specifically, the information to be transmitted to the terminal 10 is selectively switched either the information read from the magnetic card 17 through the magnetic head 2 or the information received from the contactless IC card 19 through the antenna 4. In a usual state, the signal selector selects the information read from the magnetic card 17 through the magnetic head 2 to be transmitted to the terminal 10. Whereas, in the case where the microprocessor 6 receives the information from the contactless IC card 19 through the antenna 4 and the signal selector 7 receives the switching control signal from the microprocessor 6 indicating that the IC card information should be supplied to the terminal 10, the signal selector 7 switches the communication line to select the IC card information to be outputted and transmitted to the terminal 10.

The terminal 10 serving as an example of a host device includes the I/F portion 11, a judging portion 12, a data processing portion 13 and a main control portion 14. The I/F portion 11 receives the card data 8 consisting of the clock signal and the data signal supplied from the card reader 1. The judging portion 12 judges whether the card data 8 inputted to the I/F portion 11 is of the magnetic card information read from the magnetic card 17 or of the IC card information read from the contactless IC card 19, based on a discrimination signal 9 which is sent from the microprocessor 6 to the judging portion 12. The data processing portion 13 includes a deciphering portion 13a and performs data processing of the received card data 8 such as deciphering of the inputted IC card data 8 enciphered by the microprocessor 6. The main control portion 14 controls the operation of each component in the terminal 10.

In this construction, the discrimination signal 9 sent from the microprocessor 6 to the terminal 10 usually indicates that the card data 8 to be transmitted to the terminal 10 is the magnetic card data read from the magnetic card 17. Meanwhile, in the case where the microprocessor 6 receives the IC card information from the contactless IC card 19 through the antenna 4, the discrimination signal 9 indicates that the IC card data read from the contactless IC card 19 should be sent to the terminal 10 as the card data 8.

The operation of the card system constituted as described above will be explained with reference to FIGS. 1 to FIGS. 5A-5B. First, the operation of reading the magnetic card information is explained in the case of using the magnetic card 17.

As shown in FIG. 2B, when the magnetic card 17 is slid along a running guide 21 of a card guide slot 20 formed in the terminal 10, the magnetic head 2 provided in the card reader 1 is pressure-contacted to the magnetic stripe 18 of the magnetic card 17 so that the magnetic card data recorded on the magnetic card 17 is reproduced. The reproduction data read by the magnetic head 2 is generated in separation as a clock signal (i.e., data distinction timing signal) and a data signal in waveform by the decoding circuit 3 and the separated clock and data signals are then inputted to the signal selector 7.

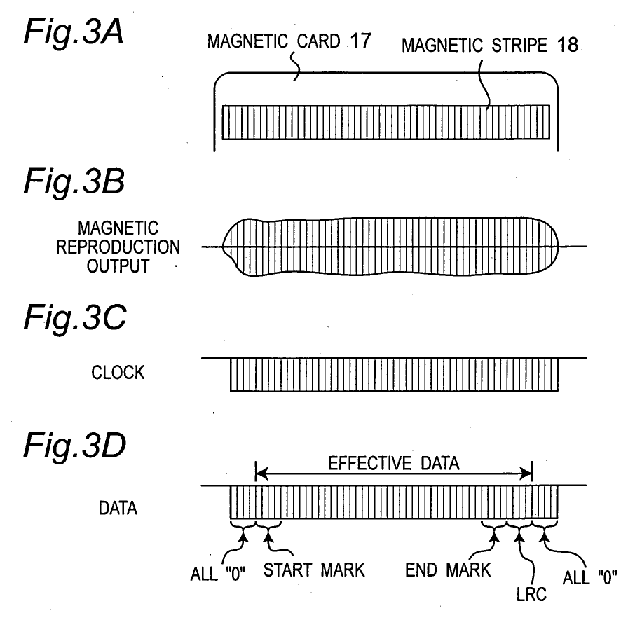

The output signals in waveform of the magnetic head 2 and the decoding circuit 3 in the card reader are shown in FIGS. 3B to 3D with respect to the magnetic stripe, wherein FIG. 3A shows the magnetic stripe portion 18 of the magnetic card 17, FIG. 3B shows the reproduction output signal through the magnetic head 2, and FIGS. 3C and 3D show the output clock signal and data signal separated from each other by the decoding circuit 3, respectively.

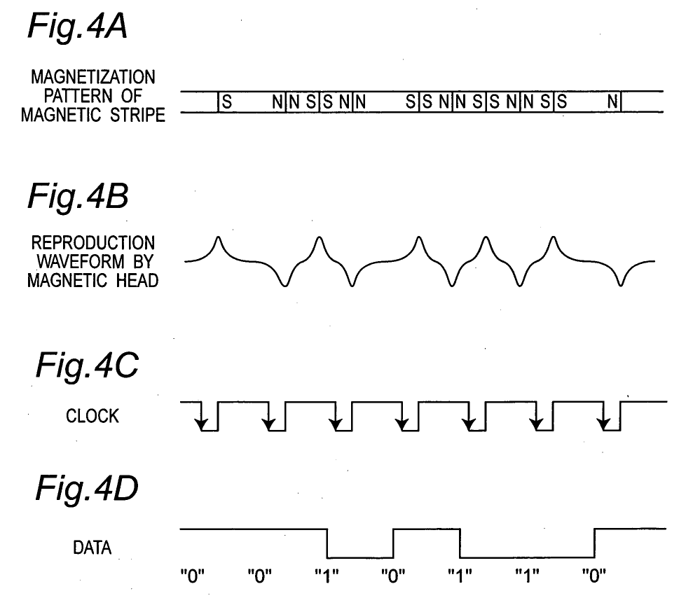

FIGS. 4A to 4D are partially enlarged timing charts corresponding to the parts shown in FIGS. 3A to 3D, respectively, wherein FIG. 4A shows a macrograph pattern of the magnetic stripe, FIG. 4B shows the reproduction waveform obtained through the magnetic head, FIG. 4C shows the waveform of the clock signal, and FIG. 4D shows the waveform of the data signal.

The signal selector 7 receives the output signal of the decoding circuit 3 and transmits the same data to the terminal 10 as it is without any processing thereto. In the terminal 10, the judging portion 12 judges based on the discrimination signal 9 that the data inputted to the I/F portion 11 is the magnetic card data of the magnetic card 17. Based on the judgment, the received magnetic card data is not processed in the terminal 10, and reference to a credit state of the card information, sales processing and the like process are performed by referring to the server 15 via the network.

Next, the processing operation of reading IC card data is explained when using the contactless IC card 19. The microprocessor 6 of the card reader 1 sends a command to the contactless IC card 19 at any time so as to periodically check whether the contactless IC card 19 exists in an operation field of the antenna 4. When the contactless IC card 19 exists in the operation field of the antenna 4, the antenna 4 receives the data from the contactless IC card 19 in response to the transmission command. The microprocessor 6 sequentially sends a command to the contactless IC card 19 according to a predetermined communication procedure, so that the microprocessor 6 reads and writes the information stored in the contactless IC card 19.

Furthermore, the microprocessor 6 has an enciphering function as shown by a portion 6a in FIG. 1 for enciphering the received IC card data. The enciphering is performed by replacing characters and signs contained in the data with other signs according to a predetermined rule so that the data received from the contactless IC card 19 cannot be deciphered by an unauthenticated terminal but can be deciphered only by an authenticated terminal 10.

The microprocessor 6 then produces the waveforms of the clock signal and the data signal based on the encrypted information so that the waveforms of the clock signal and the data signal have the same specification as that of the output signals of the decoding circuit 3 adapted for reading the magnetic card 17 as shown in FIGS. 3C, 3D, 4C and 4D. Thus, the microprocessor 6 has a waveform generating function (not shown) for generating the waveforms of the clock signal and the data signal based on the encrypted information.

More specifically, the microprocessor 6 generates the enciphered information in waveform of the clock signal and the data signal to be sent to the signal selector 7 sequentially in the order of All “0”, Start mark, Encryption data, End mark, LRC (Longitudinal Redundancy Check), and All “0.” The generated waveform data, i.e., the card data 8 of the clock signal and the data signal is transmitted to the terminal 10 through the signal selector 7. At the same time, the discrimination signal 9 is sent from the microprocessor 6 to the terminal 10 for discriminating that the card data 8 transmitted to the terminal 10 is the data of the contactless IC card 19.

Based on the discrimination signal 9, when the judging portion 12 in the terminal 10 judges that the data inputted to the I/F portion 11 is the data of the contactless IC card 19, the received card data is deciphered by the data processing portion 13 in the terminal 10 to recover the data before enciphered. Thus, the terminal 10 is allowed to confirm the reference of the credit state of the card information, to perform sales processing and the like by referring to the server 15 via the network in the same manner as in the processing of the magnetic card 17 with only a minimal change in software.

Since the deciphered data of the contactless IC card 19 is rendered to have the same specification as that of the magnetic card 17, a network environment of an established magnetic card system can be used even for processing data of an IC card. Accordingly, there is no need of specific change in the existing network even when using an IC card.

Moreover, since the data of the contactless IC card 19 transmitted on the communication line between the card reader 1 and the terminal 10 is enciphered, the security of the IC card information can be secured. In this construction, although tapping by scheming on the communication line or forgery of the enciphered data of the IC card 19 by copying to a magnetic card such as “dead copy” may be performed comparatively easily, if such a forged magnetic card is unfairly used, the copied card data will be read by the magnetic head 2 as the data of a magnetic card 17.

Therefore, the discrimination signal 9 transmitted from the microprocessor 6 to the terminal 10 indicates that the card data is data of a magnetic card. That is, the card data is not to be deciphered in the terminal 10, and in this case, since the schemed card data is enciphered data of the IC card, the data is not correctly authenticated in the terminal 10 if the card data is not deciphered. Therefore, settlement of accounts and the like processing cannot be performed by the terminal 10 using such a counterfeit card, and thus the damage by the counterfeit card can be reduced.

In addition, in a preferred embodiment of enciphering the IC card data, the number of characters of the IC card data is elongated in the enciphering process performed by the microprocessor 6. As shown in FIG. 2B of the principal part in section of the card reader, the length of the usable card is defined by a size A of the card guide slot 20.

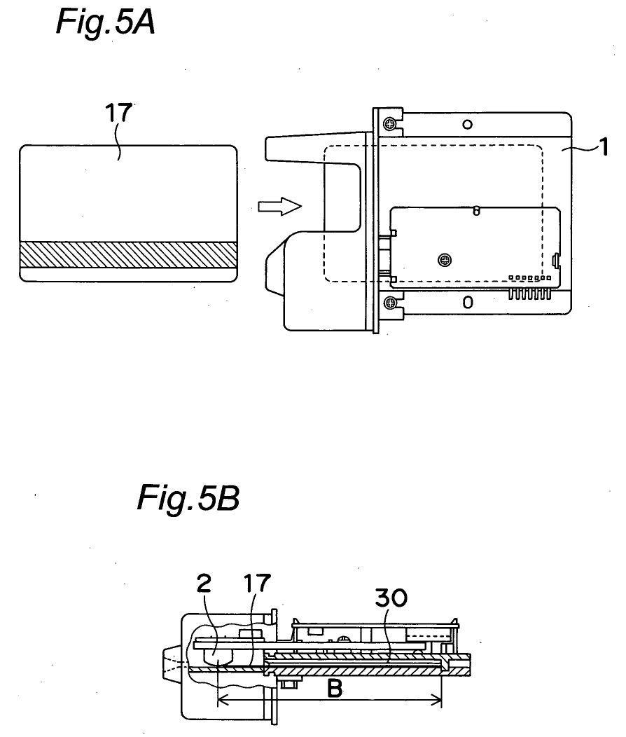

Moreover, FIGS. 5A shows an outline structure of a slot type card reader, and FIG. 5B shows the condition in section of the card reader in which the magnetic card 17 is completely inserted. That is, the data of the magnetic card 17 is read by the card reader when the magnetic card 17 is inserted in a card receipt box 30, and the length of the usable card is defined by a size B in the slot type card reader 1 as shown in FIG. 5B.

Therefore, the number of characters of the IC card data is elongated so that the entire elongated characters data exceeds the data recording capacity of the magnetic card 17 of a regular length, size A and size B shown in FIGS. 2A and 5B, thus preventing the use of the forged card. Even if a longer-sized magnetic card is created and forged for storing the entire elongated characters data, the longer-sized magnetic card can not be used in the card reader because the length of the usable card is limited in length by the size A and size B as shown in FIGS. 2B and 5B. Thus, a high effect of preventing forge of an IC card can be attained by elongating the number of characters of the IC card data when enciphered.

Moreover, the decoding circuit 3 in connection with data processing of a magnetic card is designed to have a wide frequency band width, and is allowed to reproduce the magnetic card data generally in the range of 0.4 kHz to 24.8 kHz. This frequency band range is equivalent to the reproduction speed range of 5 cm/s to 150 cm/s of the magnetic card data having a record density of 210 BPI (bits per inch).

In this arrangement, according to the record specification defined in the international standard of an ID card, the number of record characters is specified, for example, as 79 characters in the first track (i.e., track 1) with the record density of 210 BPI. In order to record 158 characters twice as the number of 79 characters in the track 1 of the ID card, the characters can be recorded by increasing the record density to have an approximately double record density (i.e., 420 BPI).

Therefore, when the card data is enciphered by elongating the number of the characters of the data, the number of the characters is largely elongated so that the number of characters (i.e., record density) exceeds the above-mentioned frequency band range of the decoding circuit 3 even when the operation speed of the magnetic card 17 is a very low speed.

By this arrangement, even when a forged magnetic card is created by scheming and the like on the communication line from the card reader 1 to the terminal 10, the data of the forged magnetic card can not be reproduced by the decoding circuit 3, and the processing of the card data becomes impossible. That is, it becomes possible to prevent creation of a forged magnetic card, and the security of an IC card data can be further improved.

It noted here that, in the present embodiment, although the card reader 1 corresponds to both the magnetic card 17 and the contactless IC card 19 in common, it may be also possible to use another type of a card reader corresponding to only a contactless IC card 19, corresponding to only a contact IC card, corresponding to a combination of plurality of these cards, or corresponding to other data careers.

For example, when a card reader only corresponds to a contactless IC card, the card information is enciphered and transmitted to a terminal 10 as the clock signal and data signal having the same specification as the communication specification for a magnetic card. Thus, the processing of the card data using the contactless IC card 19 can be attained with an improved security in the information transmission, without requiring a large change of a terminal 10. In this case, the terminal 10 has a deciphering function for deciphering the enciphered information, and this deciphering function can be realized, for example, by adding a program in software to the data processing portion in the terminal 10.

Moreover, in the present embodiment, although the card reader 1 is incorporated in the terminal 10, it is not restricted to this example and the card reader may be connected to the terminal 10 as an external apparatus of the terminal 10.

### Embodiment 2

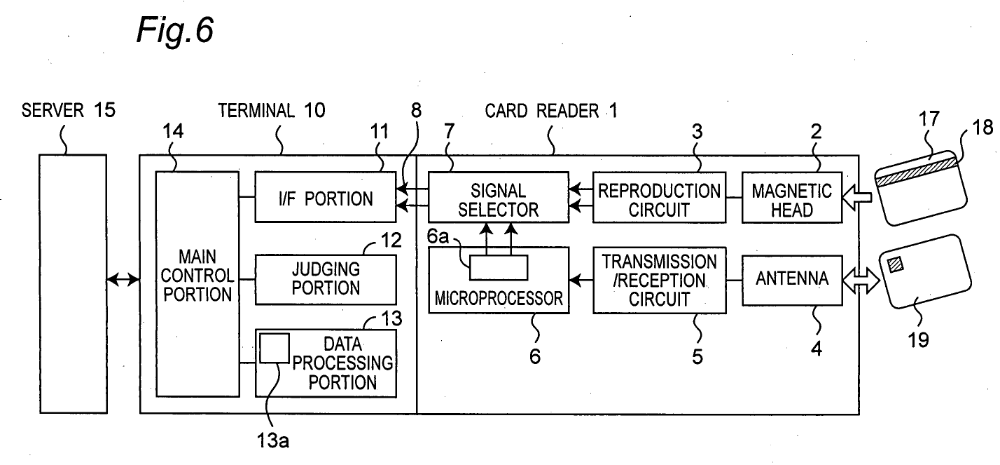

FIG. 6 is a block diagram showing a construction of a card system according to the second embodiment. In this embodiment, like parts are designated by the same reference numerals as those of the embodiment 1, and detailed explanation thereof is omitted here. The second embodiment is different from the first embodiment in the point that a discrimination signal 9 such as an independent signal is not outputted from the microprocessor 6 in the second embodiment. That is, in this embodiment, in order to discriminate whether the transmission card data is IC card data or magnetic card data, a specific pattern identifying the IC card data is superposed on the clock signal and/or data signal of the card data outputted from the signal selector 7.

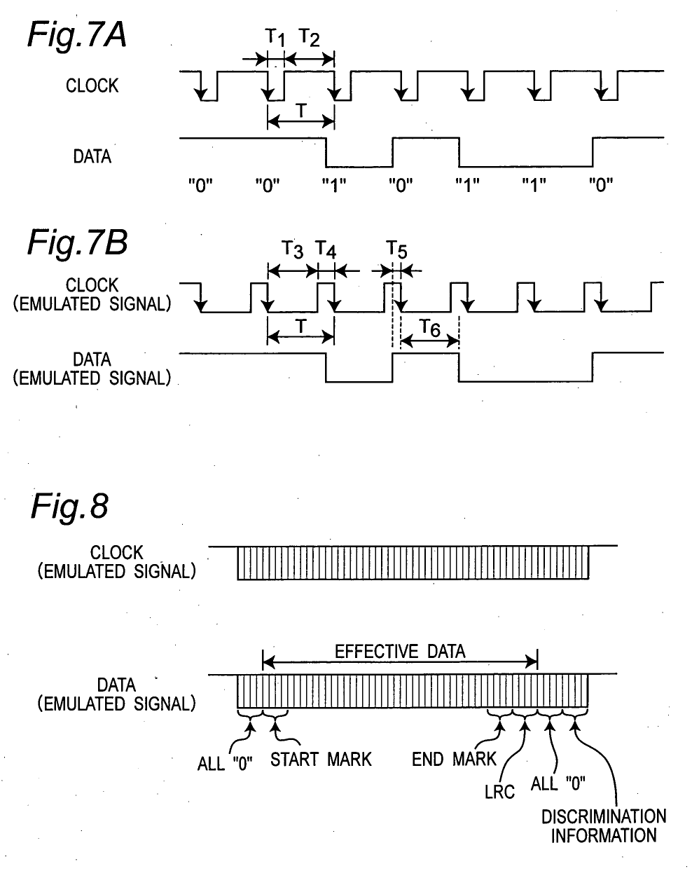

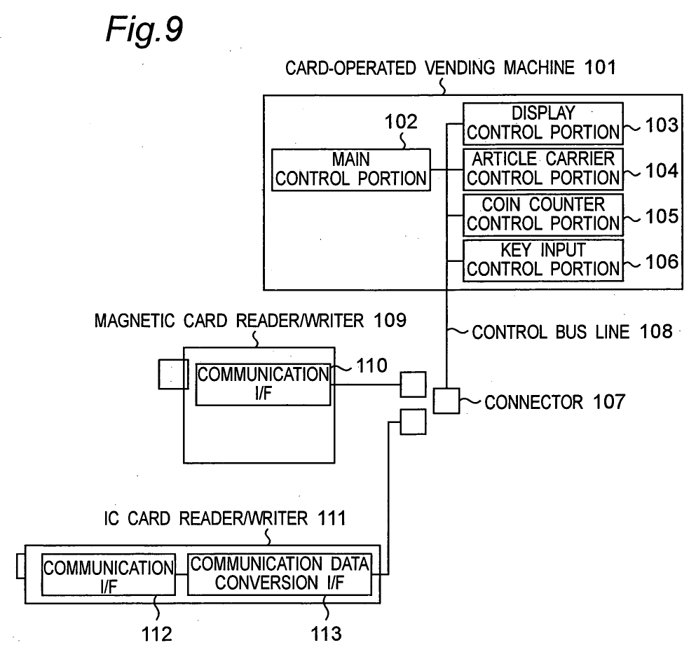

FIGS. 7A and 7B show clock and data signals of the card data outputted from the signal selector 7, wherein FIG. 7A shows an example of the card data when information of a magnetic card 17 is read, and FIG. 7B shows an example of the card data when information of a contactless IC card 19 is read.

Regarding the card data signals when the information of the magnetic card 17 is read, as shown in FIG. 7A, although a cycle (T) of the clock signal is varied according to an operation speed of the magnetic card 17, a duty defined as a ratio of a low period (T1) to a high period (T2) in each cycle (T) of the clock signal is substantially fixed.

On the other hand, since the card data signals obtained by reading the information of the contactless IC card 19 are emulated by the microprocessor 6, the emulated clock signal as shown in FIG. 7B can be outputted with an arbitrary duty, wherein the duty is defined as a ratio of a low period (T3) to a high period (T4) in one cycle (T) of the clock signal. Therefore, the clock signal outputted by the microprocessor 6 when reading the IC card is rendered to have a different duty distinguished from that of the magnetic card data.

The duty of the clock signal related to the information of the contactless IC card 19 and the duty of the clock signal related to the information of the magnetic card 17 are beforehand stored e.g. in the judging portion 12 in the terminal 10 as duty information. Thus, the judging portion 12 in the terminal 10 compares the duty of the clock signal inputted to the I/F portion 11 with the previously stored duty information, and thereby discriminates whether the card data inputted to the I/F portion 11 is of the information of the magnetic card or the information of the IC card.

Moreover, in a modified example for discrimination, by changing a period of a setup time (T5) or hold time (T6) of the clock signal as shown in FIG. 7B, it may be possible to discriminate the card data information inputted to the I/F portion 11.

Furthermore, as another superposition method for identifying the IC card data, it is also possible to utilize a time change of a cycle (T) of a clock signal as the discrimination information. That is, when reading a magnetic card, each cycle (T) of the clock signal is varied according to an operation speed of a magnetic card 17. In the construction of the card reader 1 incorporated to the terminal 10 as shown in FIGS. 2A and 2B, since a magnetic card 17 is treated by a human hand, the constant speed in operating the card cannot be expected. For this reason, the cycle (T) of the clock signal is varied with the time. For example, a certain cycle Tn of the clock signal differs from the next cycle Tn+1.

On the other hand, since the data of the contactless IC card 19 is emulated by the microprocessor 6, the emulated IC card data can be outputted by the microprocessor 6 with a constant clock period. That is, a certain cycle Tn of the clock signal becomes the same as the next cycle Tn+1. Therefore, the cycles (T) of the clock signal of the card data signals inputted to the I/F portion 11 are monitored by the main control portion 14 in the terminal 10, and when there is a time difference in the cycles of the clock signal, the inputted data is discriminated as the data of the magnetic card 17, and if there is no time difference in the cycles of the clock signal, the inputted data is discriminated as the data of the contactless IC card 19.

Contrary, in the case where the card reader 1 has a card carrying mechanism using a motor so that the magnetic card 17 is slid at a constant operation speed, the card reader may be so constructed that each cycle of the clock signal of the IC card data emulated by the microprocessor 6 is largely varied with the time lapse. In this case, when there is a large time difference in the cycles of the clock signal, the inputted data is discriminated as the data of the contactless IC card 19, and if there is a small time difference in the cycles of the clock signal, the inputted data is discriminated as the data of the magnetic card 17.

Moreover, in a preferred embodiment, the card reader may be so constructed that, when transmitting the data of the contactless IC card 19 from the card reader 1 to the terminal 10, the cycle (T) of the clock signal is made shorter than that in the case where the data of a magnetic card 17 is transmitted. Thus, the data transmission speed can be increased and the time lag accompanying the enciphering process etc. may be reduced.

As described above, according to the present embodiment, since an additional interface circuit associated with the connection between the card reader 1 and the terminal 10 can be omitted in the terminal side in order to discriminate whether the inputted data is data of a contactless IC card or data of a magnetic card. Thus, the investment cost for corresponding to an infrastructure can be reduced.

Moreover, similarly to the first embodiment, the data of the contactless IC card 19 which is enciphered by the microprocessor 6 and outputted to the signal selector 7 is made to have the same communication specification as that of the data of a magnetic card 17. Thus, application of a contactless IC card 19 to the terminal 10 is allowed only by the minimum change in software, for example, by adding a program of deciphering the IC card data, and therefore the modification on the terminal side can be suppressed to the minimum.

### MODIFIED EXAMPLE

In the second embodiment, although the discrimination between the IC card data and the magnetic card data is performed based on the difference of the cycles or duties of the clock signal, discrimination information may be sent to the terminal 10 as a part of the card data so that the discrimination can be performed. This modified example is described with reference to FIG. 8.

FIG. 8 shows the case where the discrimination information is added as a part of the emulated data of a contactless IC card 19 which is enciphered by the microprocessor 6 and outputted to the signal selector 7; wherein an upper half of FIG. 8 shows the emulated clock signal and a lower half of FIG. 8 shows the emulated data signal.

As shown in FIG. 8, the discrimination information is added to the end portion of the data. The judging portion 12 of the terminal 10 is so constructed as to check whether the end parts of the received data are all “0” or ended as a bit sequence which shows the discrimination information. By this arrangement, it becomes possible to discriminate whether the inputted data is the data of a magnetic card 17 or the data of a contactless IC card 19. That is, since the discrimination information is added in this case, the inputted data is discriminated as the data of a contactless IC card 19.

It is noted here that, although the discrimination information is added to the end position of the data in this example, the present embodiment is not limited to this and the discrimination information may be added to a head part or middle part of the data.

As described above, according to the present invention, when a magnetic card system established in advance is made applicable for an IC card to be commonly used as an IC card system, a large change in the system is not necessary and the investment cost dealing with an infrastructure can be remarkably reduced. Also, forgery and unauthorized use of the IC card can be effectively prevented, so that high security of the card information can be secured. Thus, the present invention can be utilized to upgrade an information reading device, an information reading system and the like equipment corresponding to an infrastructure for a magnetic card.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom.

1. An information reading device comprising:
an information receiving portion receiving information from a data carrier;
a microprocessor having an enciphering function of enciphering the information received by the information receiving portion; and
a communicating portion adapted to receive the enciphered information and transmit the enciphered information to a host device to thereby communicate with the host device,
wherein the information enciphered by the microprocessor is transmitted as a clock signal and a data signal to the host device through the communicating portion.

2. An information reading device comprising:
a magnetic information reading portion reading information from a magnetic recording medium;
an information receiving portion receiving information from a data carrier;
a microprocessor having an enciphering function of enciphering the information received by the information receiving portion; and
a communicating portion adapted to selectively receive one of the information read by the magnetic information reading portion and the enciphered information enciphered by the microprocessor and transmit the selectively received information to a host device to thereby communicate with the host device,
wherein the information selectively received by the communicating portion is transmitted as a clock signal and a data signal to the host device while discrimination information is transmitted from the information reading device to the host device in order for discriminating whether the transmitted information is the information read by the magnetic information reading portion or the information received by the information receiving portion.

3. The information reading device according to claim 1, wherein when the microprocessor enciphers the information received by the information receiving portion, the number of characters of the received information is elongated to exceed the maximum limit number of characters recordable on a magnetic stripe region of a magnetic card according to the recording specification defined in the International Standard of ID card.

4. The information reading device according to claim 2, wherein when the microprocessor enciphers the information received by the information receiving portion, the number of characters of the received information is elongated to exceed the maximum limit number of characters recordable on a magnetic stripe region of a magnetic card according to the recording specification defined in the International Standard of ID card.

5. The information reading device according to claim 2, wherein the discrimination information having a specific pattern indicating the transmission data being the information received from the data carrier is superposed on the clock signal to be transmitted from the communicating portion to the host device.

6. The information reading device according to claim 2, wherein the discrimination information having a specific pattern indicating the transmission data being the information received from the data carrier is superposed on the data signal to be transmitted from the communicating portion to the host device.

7. The information reading device according to claim 1, wherein the communication specification of the clock signal and the data signal to be transmitted from the communicating portion to the host device is the same as that of a magnetic card-reading device.

8. The information reading device according to claim 2, wherein the communication specification of the clock signal and the data signal to be transmitted from the communicating portion to the host device is the same as that of a magnetic card reading device.

9. An information reading system which is a combination of an information reading device and a host device receiving information from the information reading device,
said information reading device comprising:
a first receiving portion receiving information from a data carrier;
a microprocessor having an enciphering function of enciphering the information received by the first receiving portion; and
a communicating portion adapted to receive the enciphered information and transmit the enciphered information to the host device to thereby communicate with the host device,
wherein the information enciphered by the microprocessor is transmitted as a clock signal and a data signal to the host device through the communicating portion,
said host device comprising:
a second receiving portion receiving the information transmitted from the information reading device; and
a deciphering portion adapted to decipher the enciphered information transmitted from the information reading device.

10. An information reading system which is a combination of an information reading device and a host device receiving information from the information reading device,
said information reading device comprising:
a magnetic information reading portion reading information from a magnetic recording medium;
a first receiving portion receiving information from a data carrier;
a microprocessor having an enciphering function of enciphering the information received by the first receiving portion; and
a communicating portion adapted to selectively receive one of the information read by the magnetic information reading portion and the enciphered information enciphered by the microprocessor and transmit the selectively received information to the host device to thereby communicate with the host device,
wherein the information selectively received by the communicating portion is transmitted as a clock signal and a data signal to the host device while discrimination information is transmitted from the information reading device to the host device in order for discriminating whether the transmitted information is the information read by the magnetic information reading portion or the information received by the first receiving portion,
said host device comprising:
a second receiving portion receiving the information and the discrimination information transmitted from the information reading device; and
a deciphering portion adapted to decipher the enciphered information transmitted from the information reading device in the case where the discrimination information indicates that the transmitted information is the information received by the first receiving portion.

11. The information reading system according to claim 9, wherein when the microprocessor enciphers the information received by the first receiving portion, the number of characters of the received information is elongated to exceed the maximum limit number of characters recordable on a magnetic stripe region of a magnetic card according to the recording specification defined in the International Standard of ID card.

12. The information reading system according to claim 10, wherein when the microprocessor enciphers the information received by the first receiving portion, the number of characters of the received information is elongated to exceed the maximum limit number of characters recordable on a magnetic stripe region of a magnetic card according to the recording specification defined in the International Standard of ID card.

13. The information reading system according to claim 10, wherein the discrimination information having a specific pattern indicating the transmission data being the information received from the data carrier is superposed on the clock signal to be transmitted from the communicating portion to the host device.

14. The information reading system according to claim 10, wherein the discrimination information having a specific pattern indicating the transmission data being the information received from the data carrier is superposed on the data signal to be transmitted from the communicating portion to the host device.

15. The information reading system according to claim 9, wherein the communication specification of the clock signal and the data signal to be transmitted from the communicating portion to the host device is the same as that of a magnetic card reading device.

16. The information reading system according to claim 10, wherein the communication specification of the clock signal and the data signal to be transmitted from the communicating portion to the host device is the same as that of a magnetic card reading device.
